(19) United States
(12) Patent Application Publication
(10) Pub. No.: US 2014/0158817 A1
(43) Pub. Date: Jun. 12, 2014

(54) RIGID AIRSHIP UTILIZING A RIGID FRAME FORMED BY HIGH PRESSURE INFLATED TUBES

(71) Applicant: TP AEROSPACE, INC., (US)

(72) Inventor: Paul Chambers, Harvard, MA (US)

(21) Appl. No.: 13/665,379

(22) Filed: Oct. 31, 2012

Related U.S. Application Data
(60) Provisional application No. 61/553,283, filed on Oct. 31, 2011.

(51) Int. Cl. B64B 1/08; B64B 1/06; B64B 1/16

(52) U.S. Cl. CPC B64B 1/08; B64B 1/16; B64B 1/06
USPC 244/30; 244/125

(57) ABSTRACT

A rigid airship comprising a hull comprising a rigid frame covered by a skin, the rigid frame comprising a plurality of high pressure inflated tubes.

### REFERENCE TO PENDING PRIOR PATENT APPLICATION

This patent application claims benefit of pending prior U.S. Provisional Patent Application Ser. No. 61/553,283, filed Oct. 31, 2011 by Paul Chambers for HIGH PRESSURE INFLATED FRAME FOR USE IN RIGID AIRSHIPS (Attorney's Docket No. CHAMB-22 PROV), which patent application is hereby incorporated herein by reference.

### FIELD OF THE INVENTION

This invention relates to air craft in general, and more particularly to lighter-than-air craft.

### BACKGROUND OF THE INVENTION

Lighter-than-air craft are air vehicles which have a weight which is less than the weight of the air that they displace. As a result, lighter-than-air craft can be considered to “float” in the air, in much the same way that a naval craft “floats” in water. By way of example but not limitation, a recreational “hot air” balloon is one well known lighter-than-air craft.

Airships constitute a common type of lighter-than-air craft. More particularly, airships are generally characterized by an elongated, somewhat cylindrical shape and propulsion means (e.g., engines and propellers) for actively propelling the airship through the air. This is in contrast to, for example, the aforementioned recreational hot air balloon, which has a generally top-shaped configuration and lacks propulsion means.

Airships generally fall into one of three categories: a blimp, a semi-rigid airship and a rigid airship. More particularly, a blimp is essentially a large balloon having an elongated, somewhat cylindrical shape and propulsion means, with the propulsion means being attached to a rigid crew and passenger compartment which is secured below the balloon structure. A semi-rigid airship essentially comprises a rigid spine to which is attached an elongated, somewhat cylindrical balloon and propulsion means, with the propulsion means, and a crew and passenger compartment, being secured to the rigid spine below the balloon structure. A rigid airship essentially comprises a rigid frame which is covered with fabric (or a rigid skin) and which contains gas bags for providing lift to the airship, and propulsion means and crew and passenger compartments which are secured to the rigid frame anywhere within or on the rigid frame that is structurally and functionally suitable.

The present invention is directed to rigid airships, i.e., airships having a rigid frame which is covered with fabric (or a rigid skin) and which contains gas bags for providing lift to the airship.

In theory, rigid airships are preferable over other forms of airships because the “hull” of the airship, which is built about a rigid frame, has a constant size and shape, and a constant inflation pressure relative to the surrounding atmosphere, and hence an increased capacity to resist structural and aerodynamic loads regardless of the state of the lift gas cells (i.e., gas bags), atmospheric pressure and other system variables. With such a rigid airship, lift is adjusted by varying the volume of the gas-filled lift bags contained within the hull of the airship, not by varying the volume or pressure of the hull itself. Thus, with a rigid airship, the hull can be formed with a desired aerodynamic shape, and this desired aerodynamic shape is maintained at all times. By contrast, with blimps and semi-rigid airships, lift is adjusted by either (i) varying the volume of the gas lift bags within the soft hull of the airship, which requires adjustment of the pressurization of the remaining contained volume of the airship, or (ii) varying the pressure of the entire lift gas-filled internal volume of the balloon. Thus, with blimps and semi-rigid airships, it is inherently more difficult to maintain a desired aerodynamic shape for the hull of the airship as lift is adjusted. Furthermore, as an airship moves through the air, it is constantly subjected to different dynamic forces, e.g., crosswinds, updrafts, downdrafts, etc. A rigid airship, with its rigid frame, is better able to resist these different dynamic forces and still maintain the desired aerodynamic shape for the airship. By contrast, blimps and semi-rigid airships are less able to resist these different dynamic forces and can fail to maintain a desired aerodynamic shape for the hull of the airship. These differences mean that a rigid airship can go faster, and be larger, than either a semi-rigid or blimp airship.

For these reasons, the largest and most powerful airships have historically been rigid airships built about a rigid frame. For example, the famous derigibles of the 1930s were rigid frame airships.

Unfortunately, the complexity and cost of fabricating a rigid frame for a rigid airship is substantial, and presents a major impediment to the wide-spread commercial adoption of rigid airships.

More particularly, the rigid frames of rigid airships have traditionally been fabricated from lightweight metal members (“sections”), e.g., steel or aluminum sections which are secured to one another. More recently, the rigid frames of rigid airships have been fabricated from composite or carbon fiber sections which are bonded together. However, fabricating the individual frame sections, and securing them together to form the complete rigid frame structure, remains an expensive and time-consuming manufacturing process.

An attempt has been made to form the “frame” of an airship using low pressure (i.e., 8-12 psi) inflated frame sections. More particularly, inflated frame sections have been fabricated from simple plastic sheet stock which is welded together and then inflated. This plastic sheet stock has relatively low strength, as does its welds, and hence the inflated sections can only be inflated to a low pressure. As a result, each of these inflated sections has limited stiffness, and hence the inflated frame sections must have relatively small length-to-width aspect ratios in order to support the applied loads. By way of example but not limitation, these low pressure inflated frame sections are believed to have a length-to-width aspect ratio of approximately 5:1 or less, and in any case less than 10:1. Thus, in practice, these low pressure inflated frame sections are essentially large, flexible balloons which are arranged in the form of a “frame”, but which lack the rigidity of a true rigid airship frame, and hence also lack the structural capacity of a rigid airship frame. As a result, an airship built on these low pressure inflated frame sections really constitutes more of a blimp than a rigid airship, and hence has significant limitations with respect to speed, size and load.

Thus there remains a need for a new and improved rigid airship which addresses the deficiencies of the prior art.

### SUMMARY OF THE INVENTION

The present invention provides a new and improved rigid airship which addresses the deficiencies of the prior art.

More particularly, the present invention provides a novel rigid airship which utilizes a rigid frame formed by high pressure inflated tubes, whereby to provide a rigid frame which is relatively easy and inexpensive to fabricate.

In one preferred form of the present invention, there is provided a rigid frame for a rigid airship, the rigid frame comprising a plurality of high pressure inflated tubes.

In another preferred form of the present invention, there is provided a rigid airship comprising a hull comprising a rigid frame covered by a skin, the rigid frame comprising a plurality of high pressure inflated tubes.

In another preferred form of the present invention, there is provided a method for transporting an object from a first location to a second location, the method comprising:

providing a rigid airship comprising hull comprising a rigid frame covered by a skin, the rigid frame comprising a plurality of high pressure inflated tubes;

attaching the object to the rigid airship at a first location; and

moving the rigid airship from the first location to the second location.

### BRIEF DESCRIPTION OF THE DRAWINGS

These and other objects and features of the present invention will be more fully disclosed or rendered obvious by the following detailed description of the preferred embodiments of the invention, which is to be considered together with the accompanying drawings wherein like numbers refer to like parts, and further wherein:

FIGS. 1 and 2 are schematic views showing a novel rigid airship formed in accordance with the present invention, with the outer fabric (or rigid skin) of the rigid airship being rendered semi-transparent;

FIGS. 3-6 are schematic views showing another novel rigid airship formed in accordance with the present invention;

FIGS. 7 and 8 are schematic views showing still another novel rigid airship formed in accordance with the present invention;

FIGS. 9 and 10 are schematic views showing high pressure inflated tubes of the sort used to form the rigid frame of the rigid airships shown in FIGS. 1 and 2, 3-6, and 7 and 8;

FIG. 11 is a schematic view showing the structural characteristics of a high pressure inflated tube of the sort used to form the rigid frame of the rigid airships shown in FIGS. 1 and 2, 3-6, and 7 and 8; and

FIG. 12 is a schematic view showing three high pressure inflated tubes secured together so as to form a composite truss having a triangular cross-section.

### DETAILED DESCRIPTION OF THE PREFERRED EMBODIMENTS

The present invention provides a new and improved rigid airship which addresses the deficiencies of the prior art.

More particularly, the present invention provides a novel rigid airship which utilizes a rigid frame formed by high pressure inflated tubes, whereby to provide a rigid frame which is relatively easy and inexpensive to fabricate.

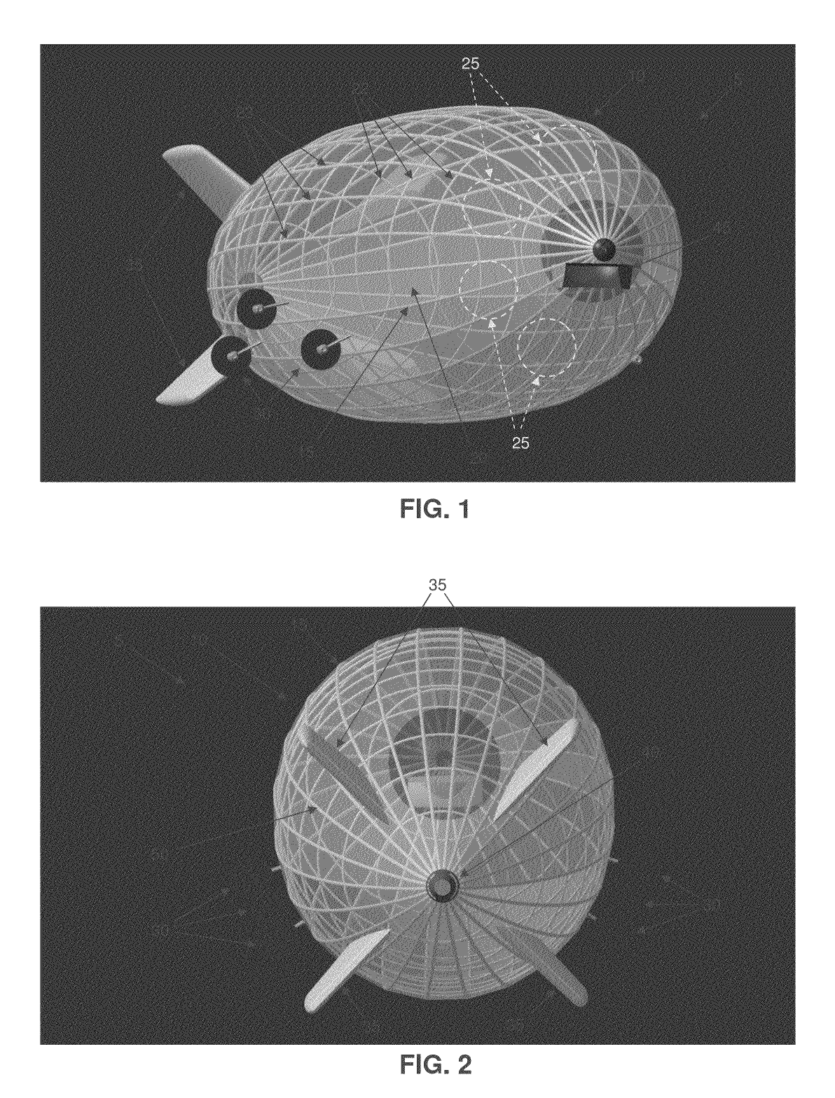

Looking first at FIGS. 1 and 2, there is shown a novel rigid airship 5 formed in accordance with the present invention. Rigid airship 5 comprises a hull 10 having an elongated, somewhat cylindrical, aerodynamic shape. Hull 10 comprises a rigid frame 15 which is covered with fabric (or a rigid skin) 20. As seen in FIGS. 1 and 2, in one form of the invention, rigid frame 15 comprises a plurality of circular hoop sections 22 connected by longitudinally-extending strut sections 23. Gas bags 25 are disposed within hull 10 so as to provide lift for the rigid airship (FIG. 1 shows several representative gas bags 25 within hull 10). Propulsion means (e.g., engines and propellers) 30 are attached to hull 10 for propelling the rigid airship through the air, and control surfaces (e.g., fins 35) are provided for steering (both lateral and vertical) the rigid airship. A directable rear thruster 40 is provided at the stern of the rigid airship so as to provide additional stern control (e.g., during docking). A cockpit 45 is provided at the bow of rigid airship 5 for piloting the craft. Compartments (not shown) for passengers and/or freight may be provided at the bottom of the rigid airship or be located internal to rigid frame 15 within hull 10 of the rigid airship 5. Alternatively, freight may be supported by cables, etc. from the bottom of the rigid airship.

In accordance with the present invention, rigid frame 15 is formed out of a plurality of high pressure inflated tubes 50 which are assembled together so as to collectively form the complete rigid frame 15. More particularly, high pressure inflated tubes 50 preferably have a relatively small diameter (e.g., 4-24 inches), and are inflated to a relatively high pressure (e.g., 25-100 psi, or higher), whereby to render high pressure inflated tubes 50 substantially rigid during normal operation. Significantly, because the high pressure inflated tubes 50 are inflated to a high pressure (e.g., 25-100 psi, or higher), the high pressure inflated tubes 50 can be formed with relatively high length-to-width aspect ratios (e.g., 20:1 or more, and in any case generally more than 10:1) without negatively affecting the rigidity of the high pressure inflated tubes 50. This greatly simplifies construction of rigid frame 15. By way of example but not limitation, where rigid frame 15 comprises a plurality of circular hoop sections 22 and longitudinally-extending strut sections 23, an entire hoop section 22 may be formed out of a single high pressure inflated tube 50, and/or an entire longitudinally-extending strut section 23 may be formed out of a single high pressure inflated tube 50.

In other words, in the present invention, the high pressure inflated tubes 50 effectively form substantially rigid “air beams” for assembling rigid frame 15. For the purposes of the present invention, the term “rigid” (or “substantially rigid”) is intended to mean having a structural integrity which provides operational performance similar to a rigid frame formed by conventional metal and/or composite sections.

Tubes 50 are secured to one another, e.g., by textile strapping, whereby to collectively form a substantially rigid frame using the high pressure inflated tubes 50.

Thus, rigid frame 15 provides the stiffness needed for structural integrity and load capacity, while being extremely lightweight and having frame sections of minimal diameter.

High pressure inflated tubes 50 are preferably formed out of an airtight knit structure, in order to (i) provide a structurally competent airtight casing able to resist the high pressure loads established within the inflatable tubes, and (ii) permit the inflatable tubes to be fabricated with the necessary pre-formed curvatures needed to achieve the desired aerodynamic shape for the airship. By way of example but not limitation, high pressure inflated tubes 50 may be fabricated out of (i) an outer structural fabric, which is woven, knitted or braided from any aramid fibers such as Kevlar or vectran or other structural fibers such as polyester, that will resist the high inflation pressure of the tube (e.g., 25-100 psi, or higher), and (ii) an inner gas-impermeable liner fabricated from a gas-impermeable plastic such as polyurethane.

High pressure inflated tubes 50 may each be independently inflated, or groups of tubes may be inflated together, or all of the tubes in the airframe may be inflated together. In general, it is preferred that each of the high pressure inflated tubes 50 be independently inflated so as to ensure that the loss of inflation in one tube does not affect the inflation of other tubes.

High pressure inflated tubes 50 may be inflated with air, or with another gas, including a gas which is lighter than air, in which case the gas inflating high pressure inflated tubes 50 may add to the lift of the rigid airship. By way of example but not limitation, high pressure inflated tubes 50 may be inflated with helium. It is preferred that the interiors of the high pressure inflated tubes 50 be connected to surge tanks so as to accommodate changes in inflation pressure, and to facilitate recovery or supply of the inflation gas, particularly in the case where the inflation gas is helium.

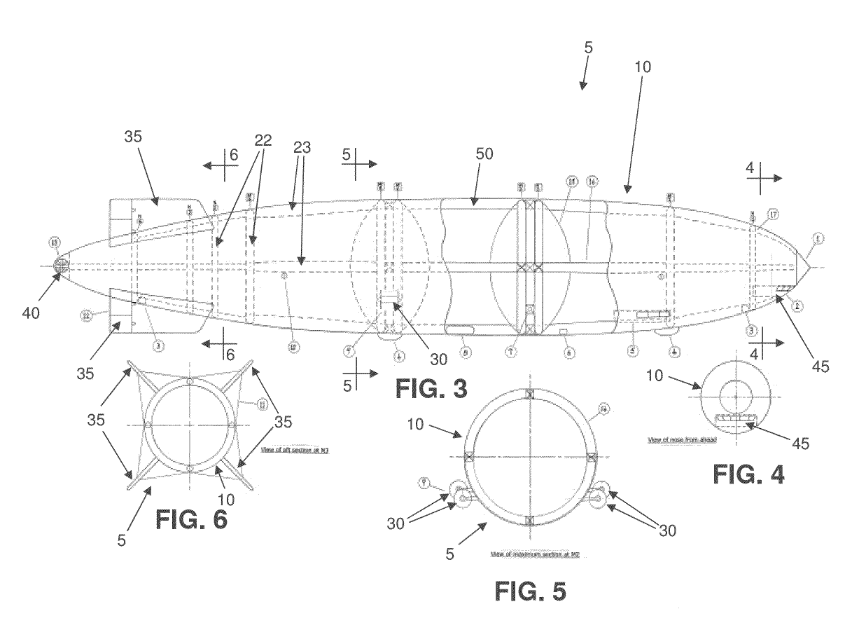

FIGS. 3-6 show another novel rigid airship 5 also formed in accordance with the present invention. The rigid airship 5 shown in FIGS. 3-6 is generally similar to the rigid airship 5 shown in FIGS. 1 and 2, except that, among other things, its rigid frame 15 (which is formed out of the aforementioned high pressure inflated tubes 50) has its circular hoop sections 22 and its longitudinally-extending strut sections 23 laid out in a somewhat different configuration.

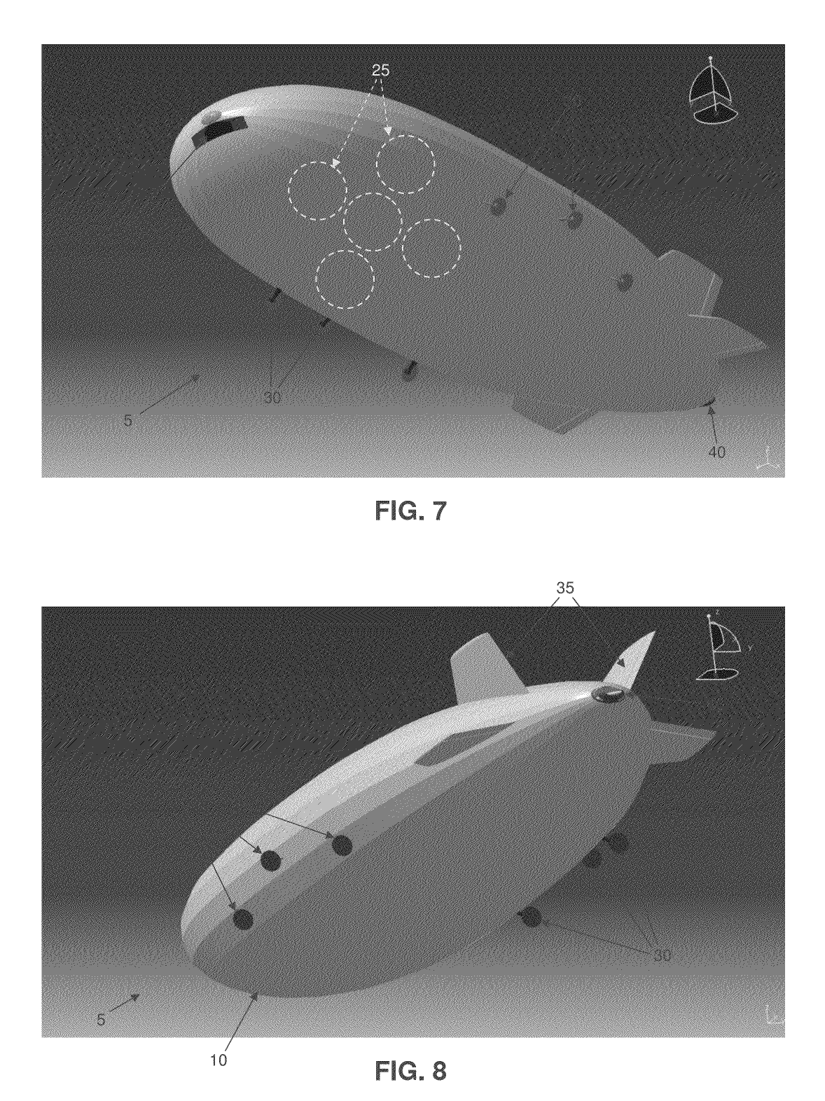

FIGS. 7 and 8 show still another novel rigid airship 5 formed in accordance with the present invention. The rigid airship 5 shown in FIGS. 7 and 8 is generally similar to the rigid airship 5 shown in FIGS. 1 and 2, except that, among other things, its rigid frame 15 (which is formed out of the aforementioned high pressure inflated tubes 50) is configured with a somewhat flattened shape, e.g., so that it has more of an ovoid cross-sectional configuration than a circular cross-sectional configuration.

Forming rigid frame 15 out of a plurality of high pressure inflated tubes 50 makes it possible to efficiently design, manufacture and assemble a rigid airship frame, and offers a number of significant advantages over traditional rigid frame constructions. The following is a partial list of the advantages associated with forming rigid frame 15 out of a plurality of high pressure inflated tubes 50.

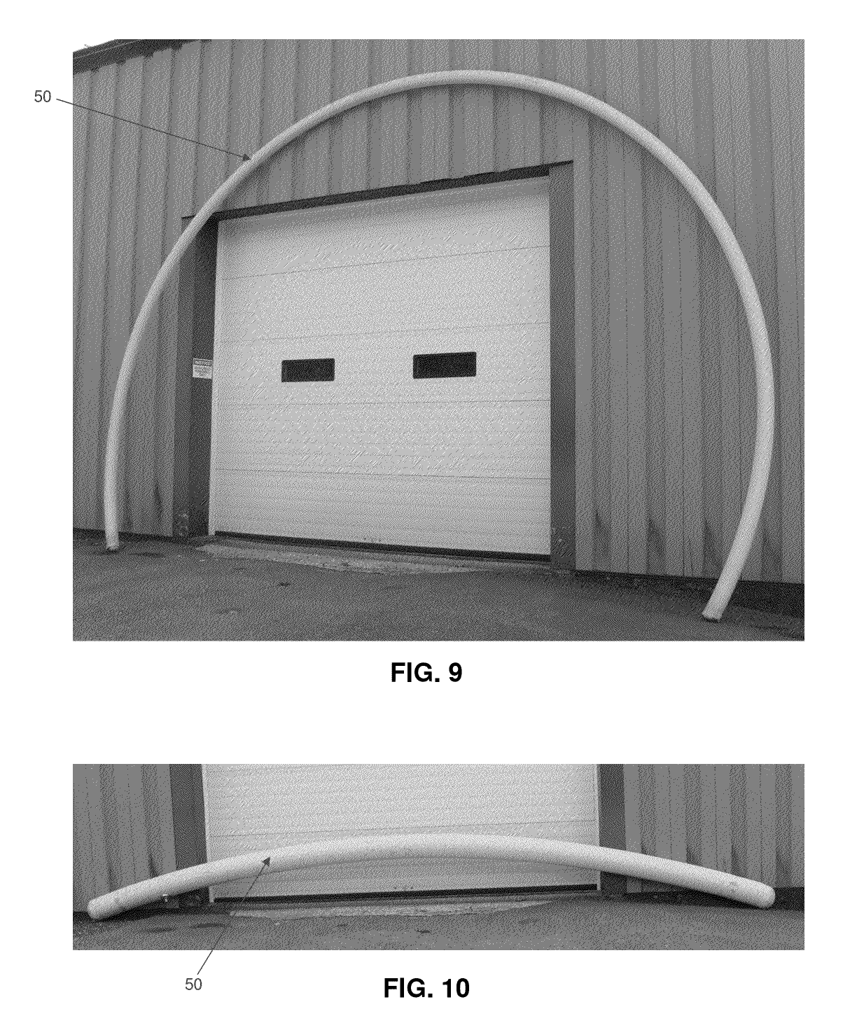

(1) Pre-Shaped High Pressure Inflated Tubes. With the present invention, the components of the rigid frame are structural inflatables and, like metal and composite sections, are capable of withstanding considerable loads. The high pressure inflated tubes 50 which are used to construct rigid frame 15 can be pre-shaped to conform to the changing curve of an airship's hull, opening up the possibility of making entire longitudinal and ring girders (i.e., the aforementioned longitudinally-extending strut sections 23 and the aforementioned hoop sections 22) in one piece (see, for example, FIGS. 9 and 10), which is a significant advantage over the prior art frame sections made of metal and composites. The curves in the individual high pressure inflated tubes 50 can be formed so as to collectively produce an aerodynamically optimized hull form.

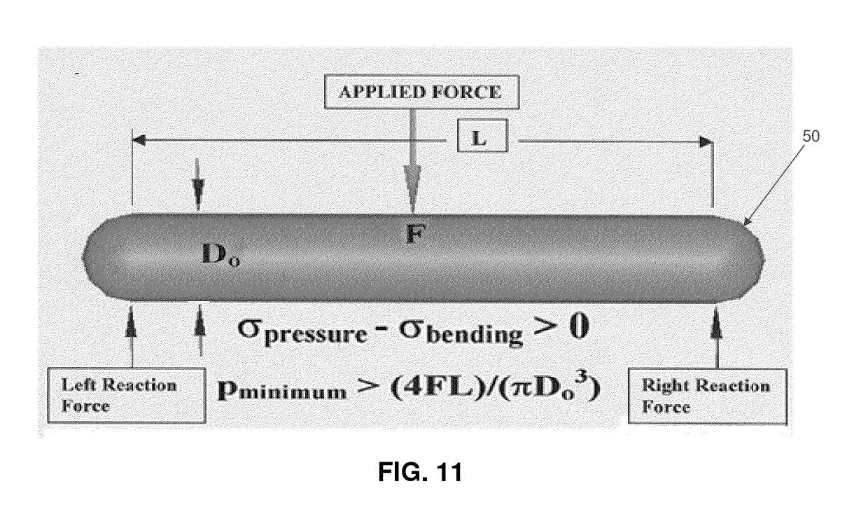

(2) Resilient High Pressure Inflated Tubes. Unlike conventional frame sections made of metal and composites, the components of the rigid frame of the present invention (i.e., high pressure inflated tubes 50), while rigid, are still extremely resilient and can withstand considerable loads without being destroyed. This is because the high pressure inflated tubes 50 have a fool-proof, yet simple, method of withstanding excessive loads, i.e., by simply flexing and then springing back into shape again once the strain returns to normal. This is achieved by internal strain energy that acts as the tube's own surge tank, providing a similar action to that of air springs and dampers on trucks (see FIG. 11). This attribute makes the high pressure inflated tubes 50 particularly effective for use in large airship frames, where they can flex as necessary without incurring fatigue. In addition, the use of the high pressure inflated tubes 50 to form rigid frame 15 makes the rigid frame highly impact tolerant. In contrast, a conventional rigid frame can fail under load and take a permanent deformation which destroys its structural capacity and, in the case of a rigid airship, its aerodynamic performance. Also, in contrast, a low pressure inflated frame may stay deformed after the excess load is removed.

(3) Light Weight. Rigid frames formed from the high pressure inflated tubes 50 are light in weight, making them ideal for airship and aircraft use, since the lighter the frame, the greater the useful payload of the vehicle.

(4) Quick Deployment. Rigid frames formed from the high pressure inflated tubes 50 are quicker to assemble and deploy, meaning both the infrastructure and manpower required is relatively low, saving time and money, and preserving resources.

(5) Durable Member. Rigid frames formed from the high pressure inflated tubes 50 are corrosion resistant and thus require little or no maintenance. They are also highly puncture resistant and surpass all certification requirements.

(6) Single Inflation. Rigid frames formed from the high pressure inflated tubes 50 may be inflated only once and can remain at the same pressure for years without needing any re-inflation. On-board monitoring systems are provided to ensure that each of the high pressure inflated tubes 50 in hull 10 stays at the required pressure.

(7) High Strength. The high pressure inflated tubes 50 are preferably manufactured using a variety of weaving, knitting or braiding techniques with special ballistic fibres that allow inflations to very high pressures. Maximum pressures of 900 psi have been achieved, but normally the pressure will vary between 25-100 psi, or more, depending on the size and load capacity of the rigid airship 5, the diameter of high pressure inflated tubes 50, etc. This means that the rigid frame 15 can be designed to be as strong as necessary for the intended role.

(8) Consistent Strength And Load Capacity. Because the high pressure inflated tubes 50 are inflated to a high pressure (e.g., 25-100 psi, or more), changes in ambient temperature only cause a minor change in the internal pressure of high pressure inflated tubes 50 and hence only cause a minor change in stiffness and load capacity (by contrast, low pressure inflatable structures change pressure significantly during ambient temperature variations, which can vary structural capacity dramatically).

(9) Compliance With Industry Standards. Rigid frames formed from the high pressure inflated tubes 50 meet and exceed aviation safety factor standards and can be certified as required.

(10) Shaped High Pressure Inflated Tubes. Inasmuch as the high pressure inflated tubes 50 can be formed with various degrees of curvature, the hull of the rigid airship can have a curvature which forms a lifting body, which is sometimes known as a “hybrid airship”. Thus, hull 10 can have an aeroform that adds aerodynamic lift to the rigid airship, resulting in a more efficient air craft. See, for example, FIGS. 7 and 8, which show a rigid airship 5 which has a hull 10 which is shaped to provide aerodynamic lift to the rigid airship.

(11) Collapsible Transport. Significantly, the high pressure inflated tubes 50 used to form rigid frame 15 are easily collapsible to facilitate transport, and may be quickly and easily inflated and assembled into the rigid frame 15 at another site.

(12) Easy Swap-Out. Due to the construction of rigid frame 15, if one or more of the high pressure inflated tubes 50 should be damaged, it may be easily “swapped-out” in the field, thereby facilitating field repair of rigid airship 5.

(13) Compensation For Failed High Pressure Inflated Tube. In addition to the foregoing, due to the construction of rigid frame 15, if one or more of the high pressure inflated tubes 50 should fail, adjacent high pressure inflated tubes 50 may be easily overinflated so as to compensate for a failed tube.

(14) Variable Geometries. In general, it is preferred that high pressure inflated tubes 50 have a substantially round cross-section, since this generally yields the highest strength for the high pressure inflated tubes 50. However, if desired, high pressure inflated tubes 50 can be formed with non-circular cross-sections, e.g., oval, triangular, rectangular, etc.

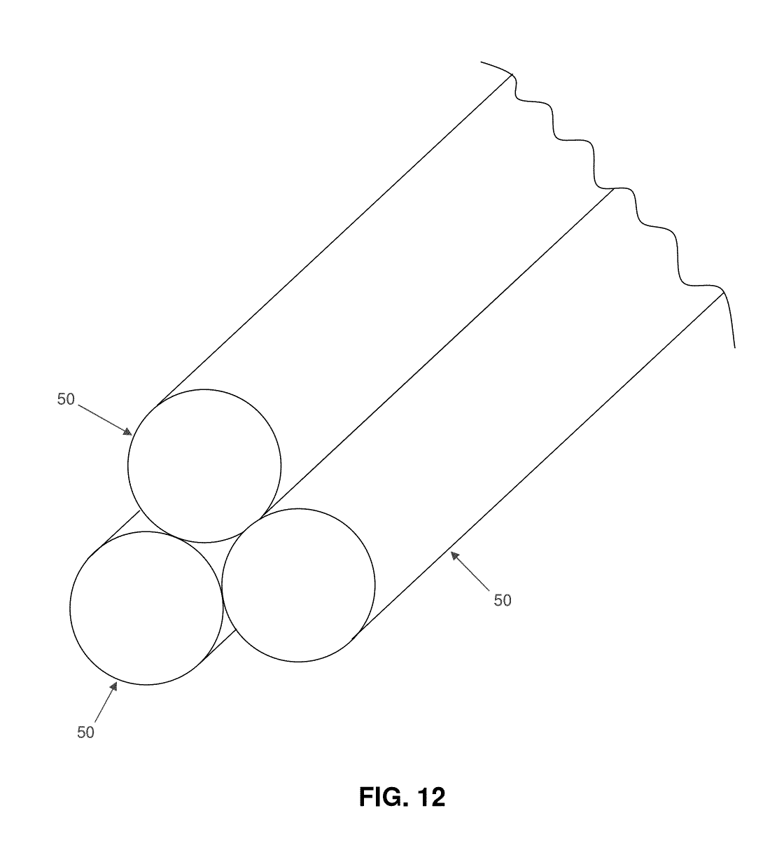

(15) “Ganging Together”, High Pressure Inflated Tubes. If desired, several high pressure inflated tubes 50 may be ganged together (e.g., by securing two or more high pressure inflated tubes 50 alongside one another) so as to further enhance their structural capacity. In addition, ganging together two or more high pressure inflated tubes 50 can provide an increased surface area for mounting other systems to rigid frame 15. By way of example, three high pressure inflated tubes 50 may be secured together so as to form a composite truss having a triangular cross-section. See, for example, FIG. 12.

(16) Lift Gas Storage. If desired, the high pressure inflated tubes 50 can be used to store lift gas, e.g., one or more of the high pressure inflated tubes 50 can be over-pressurized with helium so as to serve as a source of helium when more lift gas is required.

(17) Adjusting Pressurization To Adjust Lift. If desired, a lift gas may be used to pressurize the high pressure inflated tubes 50, and the pressure of this inflating lift gas can be adjusted as desired so as to adjust the buoyancy of the airship. By way of example but not limitation, the pressure of a lift gas filling tubes 50 may be adjusted as necessary so as to achieve zero or positive buoyancy for hull 10 of rigid airship 5.

Tables 1 and 2 provide examples of the engineering analysis used to customize the high pressure inflated tubes 50 used to form the rigid frame 15 of the rigid airship 5. Note how the high pressure inflated tubes 50 can be fabricated and filled with a lighter-than-air gas so as to add to the lift of the rigid airship.

TABLE 1
Analysis Of Toroidal Airframe Members
Geometry and Dimensions of Inflated Torus

| | |
|---|---|
| R = radius of torus at its centreline | Units are ft, ft\hat{ }2 ft\hat{ }3 |
| r = radius of the tube of the torus | pi = 3.141592654 |
| D = Outside diameter of torus = 2(R + r) | |
| A = 4pi\hat{ }2.Rr Surface area of torus | A = (2.pi.r)(2.pi.R) |
| V = 2pi\hat{ }2.Rr\hat{ }2 Internal volume of torus | V = (pi.r\hat{ }2)(2.pi.R) |
| B = bV Gross buoyancy | b = 0.0635 lb/ft\hat{ }3 |
| W = mA/9/16 Weight of torus | m = 8.4 oz/yd\hat{ }2 (Lamcotec #442) |
| L = B − W Nett lift of torus | |

| | | | | | | | | | |
|---|---|---|---|---|---|---|---|---|---|
| R r | 2 | 3 | 4 | 5 | 6 | 7 | 8 | 9 | 10 |

a) D Outside diameter

| | | | | | | | | | |
|---|---|---|---|---|---|---|---|---|---|
| 10 | 24 | 26 | 28 | 30 | 32 | 34 | 36 | 38 | 40 |
| 15 | 34 | 36 | 38 | 40 | 42 | 44 | 46 | 48 | 50 |
| 20 | 44 | 46 | 48 | 50 | 52 | 54 | 56 | 58 | 60 |
| 25 | 54 | 56 | 58 | 60 | 62 | 64 | 66 | 68 | 70 |
| 30 | 64 | 66 | 68 | 70 | 72 | 74 | 76 | 78 | 80 |
| 35 | 74 | 76 | 78 | 80 | 82 | 84 | 86 | 88 | 90 |
| 40 | 84 | 86 | 88 | 90 | 92 | 94 | 96 | 98 | 100 |
| 45 | 94 | 96 | 98 | 100 | 102 | 104 | 106 | 108 | 110 |
| 50 | 104 | 106 | 108 | 110 | 112 | 114 | 116 | 118 | 120 |

b) A Surface area

| | | | | | | | | | |
|---|---|---|---|---|---|---|---|---|---|
| 10 | 790 | 1184 | 1579 | 1974 | 2369 | 2763 | 3158 | 3553 | 3948 |
| 15 | 1184 | 1777 | 2369 | 2961 | 3553 | 4145 | 4737 | 5330 | 5922 |
| 20 | 1579 | 2369 | 3158 | 3948 | 4737 | 5527 | 6317 | 7106 | 7896 |
| 25 | 1974 | 2961 | 3948 | 4935 | 5922 | 6909 | 7896 | 8883 | 9870 |
| 30 | 2369 | 3553 | 4737 | 5922 | 7106 | 8290 | 9475 | 10659 | 11844 |
| 35 | 2763 | 4145 | 5527 | 6909 | 8290 | 9672 | 11054 | 12436 | 13817 |
| 40 | 3158 | 4737 | 6317 | 7896 | 9475 | 11054 | 12633 | 14212 | 15791 |
| 45 | 3553 | 5330 | 7106 | 8883 | 10659 | 12436 | 14212 | 15989 | 17765 |
| 50 | 3948 | 5922 | 7896 | 9870 | 11844 | 13817 | 15791 | 17765 | 19739 |

c) V Volume

| | | | | | | | | | |
|---|---|---|---|---|---|---|---|---|---|
| 10 | 790 | 1777 | 3158 | 4935 | 71063 | 9672 | 12633 | 15989 | 19739 |
| 15 | 1184 | 2665 | 4737 | 7402 | 10659 | 14508 | 18950 | 23983 | 29609 |
| 20 | 1579 | 3553 | 6317 | 9870 | 14212 | 19344 | 25266 | 31978 | 39478 |
| 25 | 1974 | 4441 | 7896 | 12337 | 17765 | 24181 | 31583 | 39972 | 49348 |
| 30 | 2369 | 5330 | 9475 | 14804 | 21318 | 29017 | 37899 | 47966 | 59218 |
| 35 | 2763 | 6218 | 11054 | 17272 | 24871 | 33853 | 44216 | 55961 | 69087 |
| 40 | 3158 | 7106 | 12633 | 19739 | 28424 | 38689 | 50532 | 63955 | 78957 |
| 45 | 3553 | 7994 | 14212 | 22207 | 31978 | 43525 | 56849 | 71949 | 88826 |
| 50 | 3948 | 8883 | 15791 | 24674 | 35531 | 48361 | 63165 | 79944 | 98696 |

d) B Gross buoyancy

| | | | | | | | | | |
|---|---|---|---|---|---|---|---|---|---|
| 10 | 50 | 113 | 201 | 313 | 451 | 614 | 802 | 1015 | 1253 |
| 15 | 75 | 169 | 301 | 470 | 677 | 921 | 1203 | 1523 | 1880 |
| 20 | 100 | 226 | 401 | 627 | 902 | 1228 | 1604 | 2031 | 2507 |
| 25 | 125 | 282 | 501 | 783 | 1128 | 1535 | 2006 | 2538 | 3134 |
| 30 | 150 | 338 | 602 | 940 | 1354 | 1843 | 2407 | 3046 | 3760 |
| 35 | 175 | 395 | 702 | 1097 | 1579 | 2150 | 2808 | 3554 | 4387 |
| 40 | 201 | 451 | 802 | 1253 | 1805 | 2457 | 3209 | 4061 | 5014 |
| 45 | 226 | 508 | 902 | 1410 | 2031 | 2764 | 3610 | 4569 | 5640 |
| 50 | 251 | 564 | 1003 | 1567 | 2256 | 3071 | 4011 | 5076 | 6267 |

e) W Weight of torus

| | | | | | | | | | |
|---|---|---|---|---|---|---|---|---|---|
| 10 | 46 | 69 | 92 | 115 | 138 | 161 | 184 | 207 | 230 |
| 15 | 69 | 104 | 138 | 173 | 207 | 242 | 276 | 311 | 345 |
| 20 | 92 | 138 | 184 | 230 | 276 | 322 | 368 | 415 | 461 |
| 25 | 115 | 173 | 230 | 288 | 345 | 403 | 461 | 518 | 576 |
| 30 | 138 | 207 | 276 | 345 | 415 | 484 | 553 | 622 | 691 |
| 35 | 161 | 242 | 322 | 403 | 484 | 564 | 645 | 725 | 806 |
| 40 | 184 | 276 | 368 | 461 | 553 | 645 | 737 | 829 | 921 |
| 45 | 207 | 311 | 415 | 518 | 622 | 725 | 829 | 933 | 1036 |
| 50 | 230 | 345 | 461 | 576 | 691 | 806 | 921 | 1036 | 1151 |

f) L Nett lift of torus

| | | | | | | | | | |
|---|---|---|---|---|---|---|---|---|---|
| 10 | 4 | 44 | 108 | 198 | 313 | 453 | 618 | 808 | 1023 |
| 15 | 6 | 66 | 163 | 297 | 470 | 679 | 927 | 1212 | 1535 |
| 20 | 8 | 87 | 217 | 396 | 626 | 906 | 1236 | 1616 | 2046 |
| 25 | 10 | 109 | 271 | 496 | 783 | 1132 | 1545 | 2020 | 2558 |
| 30 | 12 | 131 | 325 | 595 | 939 | 1359 | 1854 | 2424 | 3069 |
| 35 | 14 | 153 | 380 | 694 | 1096 | 1585 | 2163 | 2828 | 3581 |
| 40 | 16 | 175 | 434 | 793 | 1252 | 1812 | 2472 | 3232 | 4093 |
| 45 | 18 | 197 | 488 | 892 | 1409 | 2038 | 2781 | 3636 | 4604 |
| 50 | 20 | 219 | 542 | 991 | 1565 | 2265 | 3090 | 4040 | 5116 |

TABLE 2
Airframe member trade off Study
ARA520 Airship - Airbeam Trade-off Study

| Airbeam length is 60 ft | | | | | | | | | Version 1.0 |
|---|---|---|---|---|---|---|---|---|---|
| | Airbeam diameter - ft | | | Fixity coefficient, C = 1.0 | | | Note 1 | | 29-Mar-11 |
| | 0.50 | 0.75 | 1.00 | 1.25 | 1.50 | 1.75 | 2.00 | 2.25 | 2.50 |
| P = 25 psi | | | | | | | | | |
| 3600 lb/ft2 | | | | | | | | | |
| Compressive strength - lb | 707 | 1590 | 2827 | 4418 | 6362 | 8659 | 11310 | 14314 | 17671 |
| We - lb | 90838 | 306580 | 726708 | 1419351 | 2452639 | 3894699 | 5813662 | 8277656 | 11354809 |
| Wcrit - lb | 701 | 1582 | 2816 | 4404 | 6345 | 8640 | 11288 | 14289 | 17644 |
| Number of Airbeams/quadrant | 72 | 32 | 18 | 12 | 8 | 6 | 5 | 4 | 3 |
| P = 50 psi | | | | | | | | | |
| 7200 lb/ft2 | | | | | | | | | |
| Compressive strength - lb | 1414 | 3181 | 5655 | 8836 | 12723 | 17318 | 22619 | 28628 | 35343 |
| We - lb | 90838 | 306580 | 726708 | 1419351 | 2452639 | 3894699 | 5813662 | 8277656 | 11354809 |
| Wcrit - lb | 1392 | 3148 | 5611 | 8781 | 12658 | 17241 | 22532 | 28529 | 35233 |
| Number of Airbeams/quadrant | 36 | 16 | 9 | 6 | 4 | 3 | 2 | 2 | 1 |
| P = 75 psi | | | | | | | | | |
| 10800 lb/ft2 | | | | | | | | | |
| Compressive strength - lb | 2121 | 4771 | 8482 | 13254 | 19085 | 25977 | 33929 | 42942 | 53014 |
| We - lb | 90838 | 306580 | 726708 | 1419351 | 2452639 | 3894699 | 5813662 | 8277656 | 11354809 |
| Wcrit - lb | 2072 | 4698 | 8384 | 13131 | 18938 | 25805 | 33732 | 42720 | 52768 |
| Number of Airbeams/quadrant | 25 | 11 | 6 | 4 | 3 | 2 | 2 | 1 | 1 |
| P = 100 psi | | | | | | | | | |
| 14400 lb/ft2 | | | | | | | | | |
| Compressive strength - lb | 2827 | 6362 | 11310 | 17671 | 25447 | 34636 | 45239 | 57255 | 70686 |
| We - lb | 90838 | 306580 | 726708 | 1419351 | 2452639 | 3894699 | 5813662 | 8277656 | 11354809 |
| Wcrit - lb | 2742 | 6232 | 11136 | 17454 | 25186 | 34331 | 44890 | 56862 | 70248 |
| Number of Airbeams/quadrant | 19 | 8 | 5 | 3 | 2 | 1 | 1 | 1 | 1 |
| P = 125 psi | | | | | | | | | |
| 18000 lb/ft2 | | | | | | | | | |
| Compressive strength - lb | 3534 | 7952 | 14137 | 22089 | 31809 | 43295 | 56549 | 71569 | 88357 |
| We - lb | 90838 | 306580 | 726708 | 1419351 | 2452639 | 3894699 | 5813662 | 8277656 | 11354809 |
| Wcrit - lb | 3402 | 7751 | 13867 | 21751 | 31401 | 42819 | 56004 | 70956 | 87675 |
| Number of Airbeams/quadrant | 15 | 7 | 4 | 2 | 2 | 1 | 1 | 1 | 1 |
| P = 150 psi | | | | | | | | | |
| 21600 lb/ft2 | | | | | | | | | |
| Compressive strength - lb | 4241 | 9543 | 16965 | 26507 | 38170 | 51954 | 67858 | 85883 | 106029 |
| We - lb | 90838 | 306580 | 726708 | 1419351 | 2452639 | 3894699 | 5813662 | 8277656 | 11354809 |
| Wcrit - lb | 4052 | 9255 | 16578 | 26021 | 37585 | 51270 | 67075 | 85001 | 105048 |
| Number of Airbeams/quadrant | 13 | 6 | 3 | 2 | 1 | 1 | 1 | 1 | 0 |

References
1. Design Principles of Pneumatic Structures, P.S. Bulson, The Structural Engineer, June 1973
2. Analysis and Design of Flight Vehicle Structures, E.F. Bruhn, Purdue University, 1973
3. NASA/TM-2004-212773, Vectran Fiber Time-Dependent . . . , R.B. Fette, M.F. Sovinski, December 2004

Longitudinal airbeams only

| Airbeam length is 40 ft | | | | | | | | | |
|---|---|---|---|---|---|---|---|---|---|
| | Airbeam diameter - ft | | | Fixity coefficient C = 1.0 | | | Note 1 | | |
| | 0.50 | 0.75 | 1.00 | 1.25 | 1.50 | 1.75 | 2.00 | 2.25 | 2.50 |
| P = 25 psi | | | | | | | | | |
| 3600 lb/ft2 | | | | | | | | | |
| Compressive strength - lb | 707 | 1590 | 2827 | 4418 | 6362 | 8659 | 11310 | 14314 | 17671 |
| We - lb | 204387 | 689805 | 1635092 | 3193540 | 5518437 | 8763074 | 13080740 | 18624725 | 25548320 |
| Wcrit - lb | 704 | 1587 | 2823 | 4412 | 6354 | 8650 | 11300 | 14303 | 17659 |
| Number of Airbeams/quadrant | 72 | 32 | 18 | 12 | 8 | 6 | 5 | 4 | 3 |
| P = 50 psi | | | | | | | | | |
| 7200 lb/ft2 | | | | | | | | | |
| Compressive strength - lb | 1414 | 3181 | 5655 | 8836 | 12723 | 17318 | 22619 | 28628 | 35343 |
| We - lb | 204387 | 689805 | 1635092 | 3193540 | 5518437 | 8763074 | 13080740 | 18624725 | 25548320 |
| Wcrit - lb | 1404 | 3166 | 5635 | 8811 | 12694 | 17284 | 22580 | 28584 | 35294 |
| Number of Airbeams/quadrant | 36 | 16 | 9 | 6 | 4 | 3 | 2 | 2 | 1 |
| P = 75 psi | | | | | | | | | |
| 10800 lb/ft2 | | | | | | | | | |
| Compressive strength - lb | 2121 | 4771 | 8482 | 13254 | 19085 | 25977 | 33929 | 42942 | 53014 |
| We - lb | 204387 | 689805 | 1635092 | 3193540 | 5518437 | 8763074 | 13080740 | 18624725 | 25548320 |
| Wcrit - lb | 2099 | 4739 | 8439 | 13199 | 19019 | 25900 | 33841 | 42843 | 52905 |
| Number of Airbeams/quadrant | 24 | 11 | 6 | 4 | 3 | 2 | 2 | 1 | 1 |
| P = 100 psi | | | | | | | | | |
| 14400 lb/ft2 | | | | | | | | | |
| Compressive strength - lb | 2827 | 6362 | 11310 | 17671 | 25447 | 34636 | 45239 | 57255 | 70686 |
| We - lb | 204387 | 689805 | 1635092 | 3193540 | 5518437 | 8763074 | 13080740 | 18624725 | 25548320 |
| Wcrit - lb | 2789 | 6304 | 11232 | 17574 | 25330 | 34500 | 45083 | 57080 | 70491 |
| Number of Airbeams/quadrant | 18 | 8 | 5 | 3 | 2 | 1 | 1 | 1 | 1 |
| P = 125 psi | | | | | | | | | |
| 18000 lb/ft2 | | | | | | | | | |
| Compressive strength - lb | 3534 | 7952 | 14137 | 22089 | 31809 | 43295 | 56549 | 71569 | 88357 |
| We - lb | 204387 | 689805 | 1635092 | 3193540 | 5518437 | 8763074 | 13080740 | 18624725 | 25548320 |
| Wcrit - lb | 3474 | 7862 | 14016 | 21938 | 31626 | 43082 | 56305 | 71295 | 88053 |
| Number of Airbeams/quadrant | 15 | 6 | 4 | 2 | 2 | 1 | 1 | 1 | 1 |
| P = 150 psi | | | | | | | | | |
| 21600 lb/ft2 | | | | | | | | | |
| Compressive strength - lb | 4241 | 9543 | 16965 | 26507 | 38170 | 51954 | 67858 | 85883 | 106029 |
| We - lb | 204387 | 689805 | 1635092 | 3193540 | 5518437 | 8763074 | 13080740 | 18624725 | 25548320 |
| Wcrit - lb | 4155 | 9412 | 16790 | 26289 | 37908 | 51648 | 67508 | 85489 | 105590 |
| Number of Airbeams/quadrant | 12 | 5 | 3 | 2 | 1 | 1 | 1 | 1 | 0 |

Notes
1. Fixity can be increased to 4.0 with an intermediate Airbeam Ring.
2. Airbeam fabric strain-modulus estimated, dT/de = 6.75E+08 lb/ft (Ref. 3)
3. We = (pi\hat{ }3.r\hat{ }3/L\hat{ }2).(dTde) (Euler load in buckling)
4. Wcrit = C.We(1 + We/Ap) (Buckling load)
5. Number of Airbeams per quadrant = M/(Wcrit.Rad) Rad = (D-d)/2 D = 92.5 ft
6. A notional hull bending moment of M = 2,335,600 lb.ft was assumed.
7. The UTS of the woven Vectran tube is unknown and has not been accounted for in these calculations.

| Airbeam length is 30 ft | | | | | | | | | |
|---|---|---|---|---|---|---|---|---|---|
| | Airbeam diameter - ft | | | Fixity coefficient C = 1.0 | | | Note 1 | | |
| | 0.50 | 0.75 | 1.00 | 1.25 | 1.50 | 1.75 | 2.00 | 2.25 | 2.50 |
| P = 25 psi | | | | | | | | | |
| 3600 lb/ft2 | | | | | | | | | |
| Compressive strength - lb | 707 | 1590 | 2827 | 4418 | 6362 | 8659 | 11310 | 14314 | 17671 |
| We - lb | 363354 | 1226319 | 2906831 | 5677404 | 9810555 | 15578798 | 23254649 | 33110623 | 45419236 |
| Wcrit - lb | 705 | 1588 | 2825 | 4414 | 6358 | 8654 | 11304 | 14308 | 17665 |
| Number of Airbeams/quadrant | 72 | 32 | 18 | 12 | 8 | 6 | 5 | 4 | 3 |
| P = 50 psi | | | | | | | | | |
| 7200 lb/ft2 | | | | | | | | | |
| Compressive strength - lb | 1414 | 3181 | 5655 | 8836 | 12723 | 17318 | 22619 | 28628 | 35343 |
| We - lb | 363354 | 1226319 | 2906831 | 5677404 | 9810555 | 15578798 | 23254649 | 33110623 | 45419236 |
| Wcrit - lb | 1408 | 3173 | 5644 | 88223 | 12707 | 17299 | 22597 | 28603 | 35315 |
| Number of Airbeams/quadrant | 36 | 16 | 9 | 6 | 4 | 3 | 2 | 2 | 1 |
| P = 75 psi | | | | | | | | | |
| 10800 lb/ft2 | | | | | | | | | |
| Compressive strength - lb | 2121 | 4771 | 8482 | 13254 | 19085 | 25977 | 33929 | 42942 | 53014 |
| We - lb | 363354 | 1226319 | 2906831 | 5677404 | 9810555 | 15578798 | 23254649 | 33110623 | 45419236 |
| Wcrit - lb | 2108 | 4753 | 8458 | 13223 | 19048 | 25934 | 33880 | 42886 | 52953 |
| Number of Airbeams/quadrant | 24 | 11 | 6 | 4 | 3 | 2 | 2 | 1 | 1 |
| P = 100 psi | | | | | | | | | |
| 14400 lb/ft2 | | | | | | | | | |
| Compressive strength - lb | 2827 | 6362 | 11310 | 17671 | 25447 | 34636 | 45239 | 57255 | 70686 |
| We - lb | 363354 | 1226319 | 2906831 | 5677404 | 9810555 | 15578798 | 23254649 | 33110623 | 45419236 |
| Wcrit - lb | 2806 | 6329 | 11266 | 17617 | 25381 | 34559 | 45151 | 57157 | 70576 |
| Number of Airbeams/quadrant | 18 | 8 | 5 | 3 | 2 | 1 | 1 | 1 | 1 |
| P = 125 psi | | | | | | | | | |
| 18000 lb/ft2 | | | | | | | | | |
| Compressive strength - lb | 3534 | 7952 | 14137 | 22089 | 31809 | 43295 | 56549 | 71569 | 88357 |
| We - lb | 363354 | 1226319 | 2906831 | 5677404 | 9810555 | 15578798 | 23254649 | 33110623 | 45419236 |
| Wcrit - lb | 3500 | 7901 | 14069 | 22004 | 31706 | 43175 | 56411 | 71415 | 88186 |
| Number of Airbeams/quadrant | 15 | 6 | 4 | 2 | 2 | 1 | 1 | 1 | 1 |
| P = 150 psi | | | | | | | | | |
| 21600 lb/ft2 | | | | | | | | | |
| Compressive strength - lb | 4241 | 9543 | 16965 | 26507 | 38170 | 51954 | 67858 | 85883 | 106029 |
| We - lb | 363354 | 1226319 | 2906831 | 5677404 | 9810555 | 15578798 | 23254649 | 33110623 | 45419236 |
| Wcrit - lb | 4192 | 9469 | 16866 | 263843 | 38022 | 51781 | 67661 | 85661 | 105782 |
| Number of Airbeams/quadrant | 12 | 5 | 3 | 2 | 1 | 1 | 1 | 1 | 0 |
| Airbeam length is 20 ft | | | | | | | | | |
| | Airbeam diameter - ft | | | Fixity coefficient C = 1.0 | | | Note 1 | | |
| | 0.50 | 0.75 | 1.00 | 1.25 | 1.50 | 1.75 | 2.00 | 2.25 | 2.50 |
| P = 25 psi | | | | | | | | | |
| 3600 lb/ft2 | | | | | | | | | |
| Compressive strength - lb | 707 | 1590 | 2827 | 4418 | 6362 | 8659 | 11310 | 14314 | 17671 |
| We - lb | 817546 | 2759219 | 6540370 | 12774160 | 22073748 | 35052295 | 52322959 | 74498901 | 102193280 |
| Wcrit - lb | 706 | 1590 | 2826 | 4416 | 6360 | 8657 | 11307 | 14311 | 17668 |
| Number of Airbeams/quadrant | 72 | 32 | 18 | 12 | 8 | 6 | 5 | 4 | 3 |
| P = 50 psi | | | | | | | | | |
| 7200 lb/ft2 | | | | | | | | | |
| Compressive strength - lb | 1414 | 3181 | 5655 | 8836 | 12723 | 17318 | 22619 | 28628 | 35343 |
| We - lb | 817546 | 2759219 | 6540370 | 12774160 | 22073748 | 35052295 | 52322959 | 74498901 | 102193280 |
| Wcrit - lb | 1411 | 3177 | 5650 | 8830 | 12716 | 17309 | 22610 | 28617 | 35331 |
| Number of Airbeams/quadrant | 36 | 16 | 9 | 6 | 4 | 3 | 2 | 2 | 1 |
| P = 75 psi | | | | | | | | | |
| 10800 lb/ft2 | | | | | | | | | |
| Compressive strength - lb | 2121 | 4771 | 8482 | 13254 | 19085 | 25977 | 33929 | 42942 | 53014 |
| We - lb | 817546 | 2759219 | 6540370 | 12774160 | 22073748 | 35052295 | 52322959 | 74498901 | 102193280 |
| Wcrit - lb | 2115 | 4763 | 8471 | 13240 | 19069 | 25958 | 33907 | 42917 | 52987 |
| Number of Airbeams/quadrant | 24 | 11 | 6 | 4 | 3 | 2 | 2 | 1 | 1 |
| P = 100 psi | | | | | | | | | |
| 14400 lb/ft2 | | | | | | | | | |
| Compressive strength - lb | 2827 | 6362 | 11310 | 17671 | 25447 | 34636 | 45239 | 57255 | 70686 |
| We - lb | 817546 | 2759219 | 6540370 | 12774160 | 22073748 | 35052295 | 52322959 | 74498901 | 102193280 |
| Wcrit - lb | 2818 | 6347 | 11290 | 17647 | 25418 | 34602 | 45200 | 57212 | 70637 |
| Number of Airbeams/quadrant | 18 | 8 | 5 | 3 | 2 | 1 | 1 | 1 | 1 |
| P = 125 psi | | | | | | | | | |
| 18000 lb/ft2 | | | | | | | | | |
| Compressive strength - lb | 3534 | 7952 | 14137 | 22089 | 31809 | 43295 | 56549 | 71569 | 88357 |
| We - lb | 817546 | 2759219 | 6540370 | 12774160 | 22073748 | 35052295 | 52322959 | 74498901 | 102193280 |
| Wcrit - lb | 3519 | 7929 | 14107 | 22051 | 31763 | 43242 | 56488 | 71501 | 88281 |
| Number of Airbeams/quadrant | 14 | 6 | 4 | 2 | 2 | 1 | 1 | 1 | 1 |
| P = 150 psi | | | | | | | | | |
| 21600 lb/ft2 | | | | | | | | | |
| Compressive strength - lb | 4241 | 9543 | 16965 | 26507 | 38170 | 51954 | 67858 | 85883 | 106029 |
| We - lb | 817546 | 2759219 | 6540370 | 12774160 | 22073748 | 35052295 | 52322959 | 74498901 | 102193280 |
| Wcrit - lb | 4219 | 9510 | 16921 | 26452 | 38104 | 51877 | 67770 | 85784 | 105919 |
| Number of Airbeams/quadrant | 12 | 5 | 3 | 2 | 1 | 1 | 1 | 1 | 0 |

### Modifications of the Preferred Embodiments

It should be understood that many additional changes in the details, materials, steps and arrangements of parts, which have been herein described and illustrated in order to explain the nature of the present invention, may be made by those skilled in the art while still remaining within the principles and scope of the invention.

What is claimed is:

1. A rigid frame for a rigid airship, the rigid frame comprising a plurality of high pressure inflated tubes.

2. A rigid frame according to claim 1 wherein the high pressure inflated tubes are inflated to a pressure of approximately 25-100 psi.

3. A rigid frame according to claim 1 wherein the high pressure inflated tubes have a diameter of approximately 4-24 inches.

4. A rigid frame according to claim 1 wherein the high pressure inflated tubes have a length-to-width aspect ratio of at least 10:1.

5. A rigid frame according to claim 1 wherein the high pressure inflated tubes comprise an outer structural fabric and an inner gas-impermeable liner.

6. A rigid frame according to claim 5 wherein the outer structural fabric is woven with at least one from the group consisting of an aramid fiber and a structural fiber.

7. A rigid frame according to claim 6 wherein the aramid fiber comprises at least one from the group consisting of Kevlar and vectran.

8. A rigid frame according to claim 6 wherein the structural fiber comprises polyester.

9. A rigid frame according to claim 5 wherein the outer structural fabric is knitted with at least one from the group consisting of an aramid fiber and a structural fiber.

10. A rigid frame according to claim 9 wherein the aramid fiber comprises at least one from the group consisting of Kevlar and vectran.

11. A rigid frame according to claim 9 wherein the structural fiber comprises polyester.

12. A rigid frame according to claim 5 wherein the outer structural fabric is braided with at least one from the group consisting of an aramid fiber and a structural fiber.

13. A rigid frame according to claim 12 wherein the aramid fiber comprises at least one from the group consisting of Kevlar and vectran.

14. A rigid frame according to claim 12 wherein the structural fiber comprises polyester.

15. A rigid frame according to claim 1 wherein the plurality of high pressure inflated tubes are secured to one another by textile strapping.

16. A rigid frame according to claim 1 wherein at least some of the plurality of high pressure inflated tubes comprise hoop sections and others of the plurality of high pressure inflated tubes comprise strut sections.

17. A rigid frame according to claim 16 wherein the hoop sections have a substantially circular configuration.

18. A rigid frame according to claim 16 wherein the hoop sections have a substantially ovoid configuration.

19. A rigid airship comprising a hull comprising a rigid frame covered by a skin, the rigid frame comprising a plurality of high pressure inflated tubes.

20. A rigid airship according to claim 19 wherein the skin comprises a fabric.

21. A rigid airship according to claim 19 wherein the skin comprises a rigid skin.

22. A rigid airship according to claim 19 wherein the hull has a curvature to provide lift.

23. A method for transporting an object from a first location to a second location, the method comprising:
providing a rigid airship comprising hull comprising a rigid frame covered by a skin, the rigid frame comprising a plurality of high pressure inflated tubes;
attaching the object to the rigid airship at a first location; and
moving the rigid airship from the first location to the second location.

24. A method according to claim 23 wherein at least one high pressure inflated tube is pressurized with a lift gas.

25. A method according to claim 24 wherein the lift gas is helium.

26. A method according to claim 24 comprising the step of adjusting the buoyancy of the rigid airship by adjusting the pressure of the lift gas within at least one of the high pressure inflated tubes.

27. A method according to claim 24 wherein at least one high pressure inflated tube is overpressurized with a lift gas, whereby to provide storage of excess lift gas.

28. A method according to claim 24 wherein the internal pressure of at least one high pressure inflated tube is increased so as to compensate for the failure of at least one relatively small diameter, high pressure inflated tube.
